(19) United States
(12) Patent Application Publication
(10) Pub. No.: US 2026/0117356 A1
(43) Pub. Date: Apr. 30, 2026

(54) LIQUID COOLING OF A STRIP RUNNING IN A CONTINUOUS LINE

(71) Applicant: FIVES STEIN, MAISONS-ALFORT (FR)

(72) Inventors: Cyril CLAVEROULAS, Maisons-Alfort (FR); Patrice SEDMAK, Maisons-Alfort (FR)

(21) Appl. No.: 18/578,388

(22) PCT Filed: Jul. 4, 2022
(86) PCT No.: PCT/FR2022/051325

§ 371 Date: Jan. 11, 2024

(30) Foreign Application Priority Data
Jul. 12, 2021 (FR) FR2107567

(51) Int. Cl. C23C 2/00; C23C 2/02; C23C 2/40

(52) U.S. Cl. CPC C23C 2/0038; C23C 2/0222; C23C 2/0224; C23C 2/40

(57) ABSTRACT

The invention relates to a cooling chamber for cooling a metal strip running vertically in a continuous treatment line, said chamber comprising an upper cooling zone wherein a cooling liquid is sprayed onto the strip, and an intermediate zone for drying the strip, comprising at least one nozzle intended to form a blade of gas impacting the strip at an acute angle A less than 80°, and preferably less than 60°, characterized in that the nozzle is situated in an enclosure defined by the strip and profiled sheet metalwork arranged facing the strip, said profiled sheet metalwork forming a barrier to the ingress of liquid into the enclosure. The invention also relates to a continuous treatment line comprising the chamber and to a tempering method implemented in the line.

### DESIGNATION OF THE RELEVANT TECHNICAL FIELD

The invention relates to continuous lines for annealing or galvanizing metal strips equipped with a rapid liquid cooling section, whether that entails cooling by water, a mixture of water and another liquid, or any other liquid.

It relates in particular to lines equipped with “NOWFC”, which is short for “Non-Oxidizing Wet Flash Cooling”. NOWFC is thus a method and a device for ultra-rapid cooling of a metal strip with a liquid, composed mainly of water, but without oxidizing its surface.

The invention relates more particularly to liquid cooling chambers arranged on a vertical strip strand, the strip being able to circulate vertically or horizontally upstream or downstream of said chamber.

The present description relates to all dip coatings, whether zinc, aluminum, zinc and aluminum alloys, or any other type of coatings.

### TECHNICAL PROBLEMS ADDRESSED BY THE INVENTION

In a continuous line for annealing or galvanizing metal strips, a strip passes through different sections within which it undergoes a heat treatment comprising in particular heating phases, temperature maintenance and cooling phases.

The production of new steels with a very high yield strength, typically greater than 500 Mpa, requires heat treatments with high cooling rates, typically greater than 200° C./s, in order to establish complex structures with a variable distribution of different metallurgical phases, including the austenitic, ferritic, pearlitic, bainitic and martensitic phases.

In particular, AHSS and UHSS steels with very high yield strengths may be produced by controlling the cooling rates, from a totally austenitic or a mixed ferritic and austenitic metallurgical structure.

The heat treatment to be applied to the strip depends on the chemical composition of the steel, its condition at the start of the line, and the mechanical properties expected at the end of the treatment. It comprises for example a heating step up to a temperature between 750° C. and 950° C., a holding time at this temperature followed by slow cooling, for example 50° C., then ultra-rapid tempering up to room temperature or an intermediate temperature, for example 300° C., with a specific cooling rate for each metallurgical grade. For galvanization lines, a rise in temperature, for example with an induction heating, can be carried out after the rapid cooling to bring the strip to a temperature close to what the galvanizing bath was at before it was dipped in.

For example, obtaining a given steel may require an annealing temperature higher than its austenitizing temperature, then a holding time at this temperature, followed by slow cooling for a partial transformation of the austenite into ferrite and finally rapid cooling for transformation of the austenite into martensite.

Cooling can be followed by a tempering step, for example at a temperature of 200° C., aging, or “overaging”, for example at a temperature of 500° C., or a second annealing for 3^{rd}-generation grades, for example at a temperature of 750° C.

To prevent oxidation of the strip, the chambers arranged upstream and downstream of the rapid cooling chamber contain a reducing atmosphere free of oxygen and composed of hydrogenated nitrogen, typically 5% hydrogen.

The presence of oxygen would have the effect of creating iron oxides at the surface of the strip which would impair the quality of the strip and the correct coating thereof. A similar effect is obtained in the presence of water. Indeed, water in vapor form, combined with temperature, oxidizes the iron and additive elements present in the strip. For this reason, the moisture levels must be kept extremely low, typically corresponding to a dew point of between −30° C. and −40° C., i.e. a few tenths of a gram of water per kilogram of gas.

Due to the large production capacity of the annealing or galvanizing lines, the wet cooling in a cooling chamber consists of spraying, on the running strip, very high spray flow rates of water, for example greater than 1000 m³/h.

It is therefore imperative to guarantee that the water, which very abundant in the wet cooling chamber, can be contained in this chamber and that it does not contaminate the chambers arranged upstream and downstream.

Some of the liquid sprayed onto the strip evaporates when it comes in contact with it, but the large majority drips back down while still clinging to the strip, due to the Coanda effect.

To discharge this water clinging to the strip, the water is dried at the outlet of the rapid cooling.

However, insufficient drying of the strip causes damage to the return roller located under the rapid cooling chamber when the strip circulates from bottom to top. As the strip is hot when it is in contact with the return roller, for example 750° C., the roller is also brought to a high temperature. The runoff water falling onto the roller generates thermomechanical stresses likely to damage the roller.

Insufficient drying of the strip may also have the consequence of causing water retention between the strip and the return roller and of generating an aquaplaning of the strip on this return roller that can cause strip guidance problems.

Insufficient drying of the strip may also result in contamination of the downstream sections, in a reducing atmosphere with a controlled moisture content, if the means for drying the strip do not have the capacity required to eliminate all the water present on the strip before it enters a downstream chamber, with a risk of forming oxides of the iron and additives (MnO, SiO, etc.) on the surface of the strip.

In an NOWFC, where the liquid water used for cooling the strip is enriched by a stripping compound, typically formic acid, in the event of insufficient drying, the film of liquid or the droplets left on the strip at the outlet of the NOWFC will, while evaporating, leave dark marks which are residues of the stripping compound, typically non-evaporated formate. These residues have the effect of degrading the quality of the subsequent strip coating.

Another constraint to be taken into account is the non-flatness of the strip as it exits the wet cooling. It may have waves making it inappropriate to use “scrapers” to remove the water present on the strip. Furthermore, and in general, steelmakers wish to minimize the risk that mechanical parts may come into contact with their product in the line.

The temperature of the product at the outlet of the cooling section that can be greater than 100° C., the use of rubber-coated drying rollers is also inappropriate.

Finally, strip vibration or fluttering may occur spontaneously and must be taken into account for the choice of the drying system to be adopted.

The invention provides a solution to these problems by making it possible to ensure full drying of the strip after the rapid cooling, before the strip enters the heating chamber under a reducing atmosphere arranged downstream.

### Technical Background

To separate the water applied to the strip from the strip, the current technique successively implements liquid blades and gas blades.

In practice, one or two booms for spraying high-pulse liquid oriented toward the falling water have the effect of detaching it from the strip and diverting it to the rear of the blade in order to be channeled and evacuated from the cooling enclosure. The booms are fed at a pressure of a few bars, typically 7 bar.

The pulse of the liquid blades is sufficient to counter the weight and energy of the falling liquid and the quantity of liquid discharged from the rear by this means is great.

The liquid blade booms alone separate more than 95% of the falling liquid, but this is not sufficient.

High-pulse gas blades are used to complete the drying of the strip. On the other hand, they move in an extremely humid zone where numerous suspended droplets are present. The effect of the gas jet pulse is to recirculate this atmosphere toward the strip, which can lead to the strip being moistened again downstream of the gas blades, even though they are supposed to dry it.

Thus, the gas blades do not have the desired effectiveness because they can degrade the efficiency of the drying by recirculating the droplets suspended in the rapid cooling chamber.

By way of information, for a width of 1200 mm running at a speed of 300 m/min, a film of liquid of 100 um left on the strip is still equivalent to more than 5000 kg/h of liquid to be dried before entering the heating chamber under a reducing atmosphere arranged downstream. What's more, this layer is extremely heterogeneous, leaving runs and disparate droplets, which further complicates the drying of the strip.

It is therefore necessary to find a means of decreasing the amount of liquid present on the strip as much as possible after it is dried.

### SUMMARY OF THE INVENTION

According to a first aspect of the invention, there is proposed a cooling chamber for cooling a metal strip running vertically in a continuous treatment line, said chamber comprising an upper cooling zone wherein a cooling liquid is sprayed onto the strip, and an intermediate zone for drying the strip, comprising at least one nozzle intended to form a blade of gas impacting the strip at an acute angle A less than 80°, and preferably less than 60°, characterized in that the nozzle is situated in an enclosure defined by the strip and profiled sheet metalwork arranged facing the strip, said profiled sheet metalwork forming a barrier to the ingress of liquid into the enclosure.

The strip on one side and the profiled sheet metalwork of the other form an enclosure making it possible to physically isolate the gas blade within a volume wherein there is no liquid. The high-pulse gas jet inclined at an acute angle relative to the strip makes it possible to avoid the ingress of liquid into the enclosure through the opening formed by the strip and the upper end of the profile. This opening, which is necessary for the strip to pass through without contact with the profiled sheet metalwork, is limited as much as possible.

The jet of gas inclined relative to the strip makes it possible to push back the film of liquid present on the strip and the runoff liquid in the vicinity of the strip, outside the enclosure.

The flow rate, pressure, distance to the belt of the nozzle and the orientation of the gas jet play an important role in the efficiency of the drying. The flow rate is between 200 and 3000 Nm3/h on a strip face for example 1500 Nm³/h for a 1200 m wide band. The pressure is between 0.5 bar and 10 bar. It is for example 2 bar for a distance of 100 mm from the strip and a jet inclined 45°. The distance to the strip of the nozzle is between 50 and 150 mm. It is for example 100 mm. The slope of the jet is less than 60° and preferably 45°.

The geometry of the enclosure also plays a major role. Thus, in order to promote the flow of the liquid outside the enclosure, according to the invention, the profiled sheet metalwork forms a first inclined surface starting at the upper end of the profiled sheet metalwork arranged in the vicinity of the strip, the extension toward the strip of the first inclined surface forming therewith an acute angle B less than 90°, and preferably less than 60°.

The inclined surface of the profiled sheet metalwork on its upper part helps to evacuate the liquid by gravity flow and to move it away from the strip.

According to the invention, the profiled sheet metalwork forms a second inclined surface starting at the lower end of the profiled sheet metalwork arranged in the vicinity of the strip, the extension toward the strip of the second inclined surface forming therewith an acute angle C less than 90°, and preferably less than 60°.

The inclined surface of the profile on its lower part channels the liquid that may be present in the enclosure, by gravity flow, toward an opening located in the lower part of the enclosure through which the liquid is discharged out of the enclosure.

The inclined surface of the profile on its lower part originates in the vicinity of the strip, as close as possible thereto, leaving only the opening necessary for the strip to pass through without contact thereof with the profiled element.

This configuration contributes to maintaining the volume in the enclosure formed by the strip and the profiled sheet free of liquid.

In addition, according to the invention, the liquid cooling chamber comprises a lower zone wherein a tray is arranged configured to receive the cooling liquid sprayed onto the strip, said tray comprising a vertical surface arranged opposite the strip and in the vicinity thereof, the upper end of which is located in the enclosure formed by the strip and the profiled sheet metalwork, said vertical surface being configured to encourage dry gas to rise into the space defined by the strip and the vertical plane towards the interior of the enclosure and coming from a return and drying zone arranged under the tray.

The supply of dry gas inside the enclosure leads to a less moist atmosphere than what is present in the liquid cooling chamber. This has the effect of reducing the residual amount of liquid present on the strip at the outlet of the drying zone.

According to a second aspect of the invention, a continuous treatment line is proposed for a metal strip comprising a first heating chamber in a controlled reducing atmosphere configured to bring the strip to a first annealing temperature, a second heating chamber in a controlled reducing atmosphere configured to bring the strip to a second annealing temperature, or to an overaging temperature or to a tempering temperature, characterized in that it comprises a cooling chamber according to the invention arranged between the first and second heating chambers.

The liquid cooling chamber according to the invention makes it possible to avoid the presence of dark marks on the strip after the rapid liquid cooling. It also makes it possible to avoid polluting the atmosphere of the heating chamber arranged downstream which would result from the evaporation of the liquid present on the strip at the inlet thereof. Thus, an overconsumption of new atmosphere gas that would be necessary to obtain the desired dew point for the atmosphere present in the heating chamber is avoided. In addition, the pollution of the atmosphere of the heating chamber arranged downstream may have the effect of oxidizing the surface of the strip, with an increased risk when the strip is raised to a high temperature therein, for example for a second annealing. Thus, the invention makes it possible to achieve a good surface quality of the strip as it exits the heating chamber arranged downstream regardless of the tempering, overaging, or annealing temperature.

According to a third aspect of the invention, a method for tempering a metal strip implemented in a continuous processing line according to the invention is proposed, comprising:
a step of heating the strip to a first annealing temperature under a controlled non-oxidizing atmosphere;
optionally, a step of cooling the strip by spraying thereon a non-oxidizing gas, from the first annealing temperature to a quenching start temperature; a step of quenching the strip by spraying a cooling liquid thereon, from the first annealing temperature, or the quenching start temperature, to a quenching end temperature;
a step of dewatering and drying the strip;
a step of heating the strip to a second annealing temperature, or to an overaging temperature, or to a tempering temperature, carried out under a non-oxidizing controlled atmosphere.

The confinement of the nozzles forming gas blades in enclosures forming a barrier to the ingress of liquid into said enclosure makes it possible to limit the amount of residual water present on the strip after it is dewatered. The strip is then dried before it enters the heating chamber in a controlled reducing atmosphere arranged downstream. This configuration makes it possible to implement the tempering method according to the invention, which produces strips with an excellent surface quality due to the absence of dark marks on the strip after the liquid cooling and the absence of oxidation of the strip during the liquid cooling and in the heating chamber in a controlled reducing atmosphere arranged downstream due to the non-pollution of this atmosphere resulting from the absence of liquid on the strip when it enters the heating chamber.

The acute angles described above are measured relative to a plane perpendicular to the direction of the strip.

### BRIEF DESCRIPTION OF THE FIGURES

Further features and advantages of the invention will become apparent from the following detailed description, which can be understood with reference to the accompanying drawings, wherein:

FIG. 1 is a schematic and partially shown view of a galvanizing line according to the invention;

FIG. 2 is a schematic and partially shown view of a wet cooling section according to the prior art;

FIG. 3 is a schematic and partially shown view of a wet cooling section according to the invention;

FIG. 4 is a partial enlargement of a part of FIG. 3, and

FIG. 5 is a simplified representation of FIG. 4.

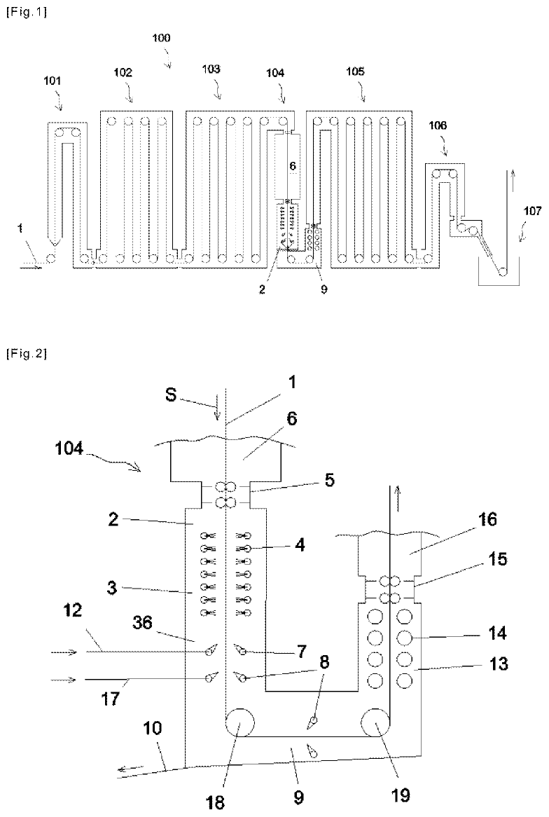

The diagram of FIG. 1 of the accompanying drawings schematically and partially shows, in longitudinal view, a vertical furnace galvanization line 100 according to one embodiment of the invention. It comprises, successively and in the direction of travel of the strip 1, a preheating chamber 101, a heating chamber 102, a holding chamber 103, a cooling section 104 comprising a gas cooling chamber 6, a liquid cooling chamber 2, a return and drying chamber 9, then a heating chamber 105, a furnace outlet section 106, and a hot-dip galvanizing section 107.

Depending on the steel grade and the thermal cycle necessary to obtain the targeted mechanical properties, the gas cooling chamber 6 for example allows slow cooling of the strip from an annealing temperature, for example 900° C., to a tempering start temperature, for example 700° C. A more rapid cooling of the strip in the chamber 6 can also be carried out, but it will nevertheless remain less rapid than that obtained in the liquid cooling chamber 2. Indeed, the gas cooling, typically by spraying a mixture of nitrogen and hydrogen, makes it possible to achieve cooling rates of the order of 100° C./s for steel strips of 1 mm thickness. Liquid cooling makes it possible to achieve it with cooling rates up to 1000° C./s for a steel strip of 1 mm thickness.

Referring to the diagram of the appended FIG. 2, a cooling section 104 according to the prior art can be partially seen.

The strip 1 enters the gas cooling chamber 6 by circulating from top to bottom according to the direction of travel indicated by the arrow S. At the outlet of this chamber there is an airlock 5 ensuring a separation between the controlled reducing atmosphere present in the gas cooling chamber, consisting of a mixture of nitrogen and hydrogen, and the humid atmosphere of the liquid cooling chamber 2 which is downstream. The airlock shown comprises two pairs of rollers with an air draw-off between the two pairs of rollers. Other airlock configurations are possible, in particular an airlock with three pairs of rollers comprising a draw-off between the two pairs of rollers located on the side of the gas cooling chamber and an injection of gas between the two pairs of rollers located on the side of the liquid cooling chamber.

The strip first passes through an upper liquid cooling zone 3 wherein nozzles 4 spray a cooling liquid onto the strip, for example an acid solution containing water and 3% formic acid.

At the outlet of the liquid cooling zone 3, in the direction in which the strip is running, the strip then passes through an intermediate drying zone 36 of the strip.

In this zone there are liquid blades formed by flat jet nozzles 7 intended to remove most of the run-off liquid present on the strip. The jets are inclined relative to the strip by an acute angle in order to promote the separation of the water film present on the surface of the strip. The nozzles 7 are supplied with the same liquid as the cooling liquid, by means of a supply duct 12.

The set of liquid blades is followed by gas blades intended to remove the liquid still present on the strip. These gas blades are formed by flat-jet nozzles 8 fed with nitrogen, or a mixture of nitrogen and hydrogen, by means of a supply duct 17. The nitrogen can be at room temperature or at a higher temperature. These gas blades have substantially the same inclination as the liquid blades.

The liquid and gas blades cover the entire width of the strip. On one face of the strip, they can be obtained with a single nozzle, the length of which is at least equal to the maximum width of the strip or with a plurality of nozzles arranged over the width of the strip.

The strip 1 then passes through a lower return zone 9 wherein two deflector rollers 18, 19 are arranged. It forms a tray wherein the liquid sprayed onto the strip is collected by the cooling nozzles 4 and the nozzles 7 forming a liquid blade before being discharged via a discharge duct 10. This lower zone may comprise nozzles 8 forming complementary gas blades.

The strip 1 then passes through a dryer 13 equipped with heating tubes 14 intended to dry the strip by radiation. Drying can also be carried out by convection or by a combination of radiation and convection.

On exiting of this part 13, the strip passes through an atmosphere separation airlock 15 between the part 13 and the chamber 16 located downstream in the direction in which the strip travels. The airlock shown comprises two pairs of rollers with an air draw-off between the two pairs of rollers, but other airlock configurations are possible.

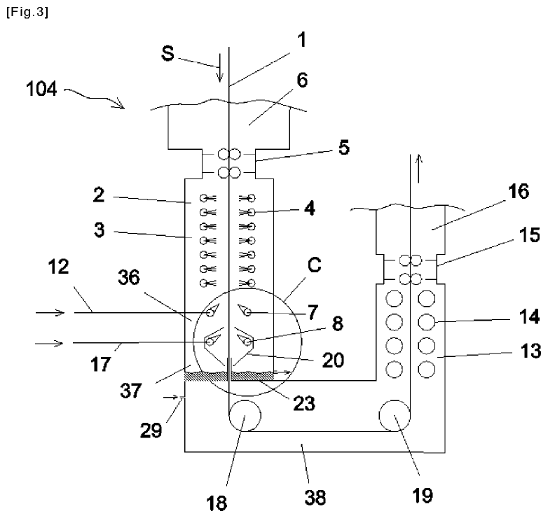

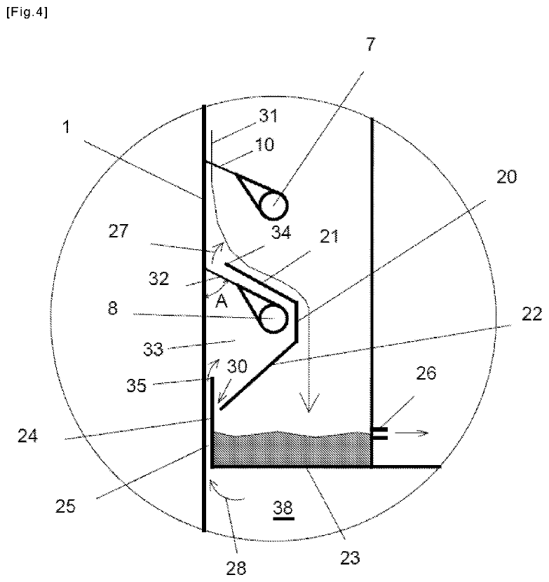

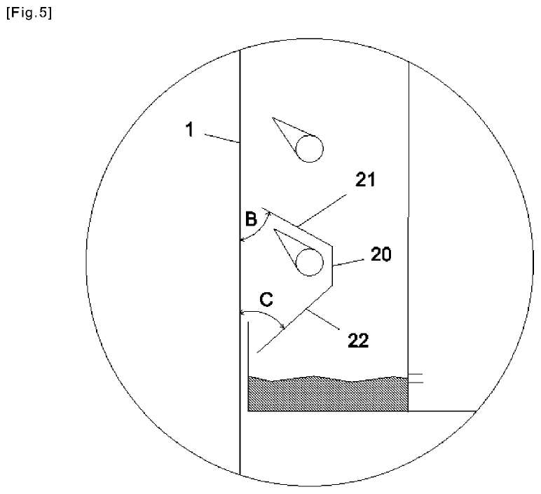

Referring to the diagram of the appended FIG. 3, a cooling section 104 according to one embodiment of the invention can be partially seen, and with reference to the attached FIG. 4, an enlargement of the area surrounded by a circle C in FIG. 3 can be seen. In order to simplify FIG. 4, only the equipment present on the right-hand strip side is shown. FIG. 5 is a simplified view of FIG. 4 for viewing the angles B and C of the inclined surfaces of the profiled sheet metalwork.

The strip 1 on one side and a profiled sheet metalwork 20 of the other form an enclosure 33 which surrounds the nozzle 8 forming a gas blade 32. The assembly of the liquid to be evacuated flows outside this chamber to the tray 23 before being discharged to an external exchanger, not shown, through the exhaust duct 26.

The profiled sheet metalwork extends over the entire width of the strip and surrounds the nozzle 8 over its entire width, or the plurality of nozzles 8 depending on whether a single nozzle or multiple nozzles are used to cover the width of the strip.

The profiled sheet metalwork closes toward the strip, on its upper part and on its lower part. The spacing with the strip is chosen to limit the passage section to the minimum in order to avoid any contact of the strip with the profiled sheet metalwork while allowing the discharge of the gas jet without stress. A clearance of 50 to 100 mm between the strip and the sheet metalwork 20 is recommended.

The gas jet causes the liquid to rise along the strip outside the enclosure 33. The liquid then drops over the profiled upper part of the sheet metalwork. This comprises a slope 21 which promotes the flow of the liquid outside the opening, before it falls into a tray 23 or it is collected and then discharged through a duct 26.

The internal atmosphere in the enclosure 33 is physically separated by the profiled sheet metalwork from the wet environment of the rest of the liquid cooling chamber 2, but not impermeably. In addition to the opening on the upper part, orifices 30 exist on the lower part of the profiled sheet metalwork to discharge any liquid which could unintentionally be within the enclosure. These orifices 30 have a reduced opening surface area to limit the inlet of wet gas into the enclosure 33. A slope 22 on the lower part of the profiled sheet metalwork promotes this flow.

The tray 23 comprises an ascent 24 along the strip, on either side thereof. The distance between the strip and the ascent 24 is reduced to that necessary to avoid any risk of contact of the strip against the latter, even in the event of fluttering of the strip. It is for example 50 to 100 mm.

Under the tray 23 there is a return and drying zone 38. The pulse of the gas blade formed by the nozzle 8 creates a rising of the gas contained in the return and drying zone 38 by suction. Gas thus flows from the bottom upwards between the rising 24 from the tray 23 and the strip, as shown by the arrow 28 in FIG. 4.

The return and drying zone 38 comprises a gas injection point 29 making it possible to inject nitrogen therein, or a mixture of nitrogen and hydrogen. This injection makes it possible to place in this zone a drier atmosphere than that present in the liquid cooling chamber. This injection is carried out by means of a supply not shown. A draw-off of the air present in this return and drying zone 38 is carried out at the air separation airlock 15 so as to ensure a renewal of the air present in the return and drying zone 38.

The return and drying zone 38 is equipped with heating tubes 14 intended to completely dry the strip by radiation before it enters the heating chamber located downstream.

1. A liquid cooling chamber for cooling a metal strip running vertically in a continuous treatment line, said chamber comprising an upper cooling zone wherein a cooling liquid is sprayed onto the strip, and an intermediate zone for drying the strip, comprising at least one nozzle intended to form a blade of gas impacting the strip at an acute angle A less than 80°, and preferably less than 60°, the nozzle being situated in an enclosure defined by the strip and profiled sheet metalwork arranged facing the strip, said profiled sheet metalwork forming a barrier to the ingress of liquid into the enclosure, characterized in that
the profiled sheet metalwork forms a first inclined surface starting at the upper end (34) of the profiled sheet metalwork arranged in the vicinity of the strip, the extension towards the strip of the first inclined surface forming therewith an acute angle B less than 90°, and preferably less than 60°, and the profiled sheet metalwork forms a second inclined surface originating at the lower end of the profiled sheet metalwork arranged in the vicinity of the strip, the extension toward the strip of the second inclined surface forming therewith an acute angle C less than 90°, and preferably less than 60°.

2. The liquid cooling chamber according to claim 1, further comprising a lower zone wherein a tray configured to receive the cooling liquid sprayed onto the strip is arranged, said tray comprising a vertical surface arranged opposite the strip and in the vicinity thereof, the upper end of which is located in the enclosure formed by the profiled strip and the profiled sheet metalwork, said vertical surface being configured to encourage dry gas to rise into the space defined by the strip and the vertical plane towards the interior of the enclosure and from a returning and drying zone arranged under the tray.

3. A continuous treatment line for a metal strip comprising a first heating chamber, in a controlled reducing atmosphere configured to bring the strip to a first annealing temperature, a second heating chamber in a controlled reducing atmosphere configured to bring the strip to a second annealing temperature, or to an overaging temperature or to a tempering temperature, characterized in that it comprises a cooling chamber according to claims 1 or 2, arranged between the first and second heating chambers.

4. A method for tempering a metal strip implemented in a continuous processing line according to the preceding claim, comprising:
a step of heating the strip to a first annealing temperature under a controlled non-oxidizing atmosphere;
optionally, a step of cooling the strip by spraying thereon a non-oxidizing gas, from the first annealing temperature to a quenching start temperature;
a step of quenching the strip by spraying a cooling liquid thereon, from the first annealing temperature, or the quenching start temperature, to a quenching end temperature;
a step of dewatering and drying the strip;
a step of heating the strip to a second annealing temperature, or to an overaging temperature, or to a tempering temperature, carried out under a non-oxidizing controlled atmosphere.
